(19) United States
(12) Patent Application Publication
(10) Pub. No.: US 2006/0198067 A1
(43) Pub. Date: Sep. 7, 2006

(54) Extension cord having open neutral during fault detection trip

(76) Inventor: James N. Pearse, Libertyville, IL (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/322,460

(22) Filed: Dec. 30, 2005

Related U.S. Application Data
(60) Provisional application No. 60/640,503, filed on Dec. 30, 2004.

(51) Int. Cl. H02H 3/00; H02H 9/08

(52) U.S. Cl. 361/42

(57) ABSTRACT

The present invention is directed to an open neutral and fault detection trip circuit having minimal circuitry and low power consumption. In one embodiment, the circuit is located in a plug of an extension cord for connection between a source of power such as a service panel and a load such a window air conditioner. The circuit includes a circuit interrupter for breaking a conductive path between the line side phase and neutral conductors, and the load side phase and neutral conductors. A trip circuit is coupled to operate the circuit interrupter to break the conductive path upon detecting the opening of the line side neutral conductor which is normally referred to as open neutral condition. The trip circuit consists of a transformer having three windings coupled in subtractive polarity and a diode coupled to the circuit interrupter to provide an open neutral trip signal when the neutral conductor is open and, at the same time, a fault occurs from the phase conductor to ground. In response to an open neutral condition and a fault, the flow of current to a load such as a window air conditioner is interrupted. The circuit disclosed detects an open neutral condition with minimal circuitry and power consumption so that it can be fitted into an electrical plug. If there is an open neutral and a fault does not occur, then there is no interruption of the flow of current

This application claims the benefit of the filing date of a provisional application having Ser. No. 60/640,503 which was filed on Dec. 30, 2004.

### BACKGROUND OF THE INVENTION

1. Field of the Invention

This invention is directed generally to a leakage current detection interrupter (LCDI) with open neutral detection.

2. Description of the Prior Art

The electrical extension cord in use today includes a plug, usually comprising two of three prongs, an electrical conducting cord typically comprising two or three insulated wires several feet in length and a terminal connector or receptacle for receiving one or more electrical plugs to power lamps, a television, household appliances, an air conditioner, etc. A grounded extension cord includes a plug having three prongs and a three conductor insulated wire cord where two conductors are utilized for phase and neutral or return power and the third conductor is used as a common ground. While extension cords provide many advantaged, there are some disadvantages that are also associated with their use. For example, extension cords are often left underneath rugs where they are trampled upon, or they are pinched by doors and furniture which can lead to arcing or short circuiting which can cause a fire. Extension cords also frequently tend to be left coiled where heat can concentrate, or are overloaded to the point of destruction by fire. Given the number of dangerous situations which can develop pursuant to extension cord use and abuse, such as residential fires and electrical shock, an extension cord design which offers some protection in anticipation of homeowner/user abuse is desired.

U.S. Pat. No. 5,642,248 assigned to Leviton Manufacturing Co., Inc. of Little Neck, N.Y. discloses an electrical extension cord where the insulated phase, neutral and ground conductors are surrounded by a braided sensing shield, The braided shield is electrically connected at the receptacle to the ground conductor. Leakage current released from the conductors may be collected in the shield and detected by a circuit interrupter such as a leakage current detector interrupter. The purpose of the shield is to capture any type of leakage current within the extension cord and transfer it to ground such that the leakage current detector interrupter may detect the current imbalance and interrupt the circuit. This type of device is commonly known as a leakage current detection interrupter (LCDI).

However, present day leakage current detectors may exhibit various problems. For example, one problem that can occur is when a device is plugged into an outlet in such a way that electricity is supplied to the phase terminal but not to the neutral terminal. When this happens the interrupting device is not powered and, therefore, can not operate because there is no return or neutral circuit. But, high voltage is still available to the user and, therefore, a potentially dangerous situation can exist. Relays that are non-latchable with normally open contacts are typically used to prevent high voltage being available to the user when this type of open neutral condition exists. These normally open relay will not close the contacts unless a return circuit is available, and will open if the neutral circuit should open. However, this type of relay is relatively large and consumes a large amount of power. Therefore, what is needed is an LCDI circuit with open neutral detection but with minimal circuitry and low power consumption.

### SUMMARY OF THE INVENTION

The present invention is directed to an open neutral and fault detection trip circuit having minimal circuitry and low power consumption. In one embodiment, the circuit is located in a plug of an extension cord for connection between a source of power such as a service panel and a load such a window air conditioner. The circuit includes a circuit interrupter for breaking a conductive path between the line side phase and neutral conductors, and the load side phase and neutral conductors. A trip circuit is coupled to operate the circuit interrupter to break the conductive path upon detecting the opening of the line side neutral conductor which is normally referred to as open neutral condition. The trip circuit consists of a transformer having three windings coupled in subtractive polarity and a diode coupled to the circuit interrupter to provide an open neutral trip signal when the neutral conductor is open and, at the same time, a fault occurs from the phase conductor to ground. In response to an open neutral condition and a fault, the flow of current to a load such as a window air conditioner is interrupted. The circuit disclosed detects an open neutral condition with minimal circuitry and power consumption so that it can be fitted into an electrical plug. If there is an open neutral and a fault does not occur, then there is no interruption of the flow of current

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features and advantages of the present invention will become more fully apparent from the following detailed description, the appended claim, and the accompanying drawing in which similar elements are given similar reference numerals wherein:

FIG. 1 is a schematic diagram of an electrical extension cord in accordance with the principles of the invention; and

FIG. 2 is a schematic of an open neutral during fault detection trip circuit in accordance with the principles of the invention.

### DETAILED DESCRIPTION OF THE INVENTION

The present invention provides a new and improved circuit for use with an extension cord for detecting and interrupting the flow of electricity through the cord when there is an open neutral during fault detection with minimal circuitry and low power consumption. In one embodiment, the circuit is located in a plug of an extension cord for connection between a source of power such as a service panel and a load such as a window air conditioner. The circuit includes a circuit interrupter for selectively interrupting a conductive path between line side phase and neutral conductors, and the load side phase and neutral conductors. A trip circuit is coupled to operate the circuit interrupter to break the conductive path upon detecting a fault when the line side neutral conductor is open. The trip circuit uses a three winding transformer in combination with a diode where the transformer is connected to be in subtractive polarity. The trip circuit, in combination with an interrupt circuit, interrupts the flow of current in the cord if a fault is detected while there is an open neutral condition. Thus, in response to detecting the opening of the neutral conductor, the circuit here disclosed interrupts the flow of current to a load such as a window air conditioner. The disclosed circuit provides open neutral detection with minimal circuitry and power consumption so that it can be fitted into an electrical plug.

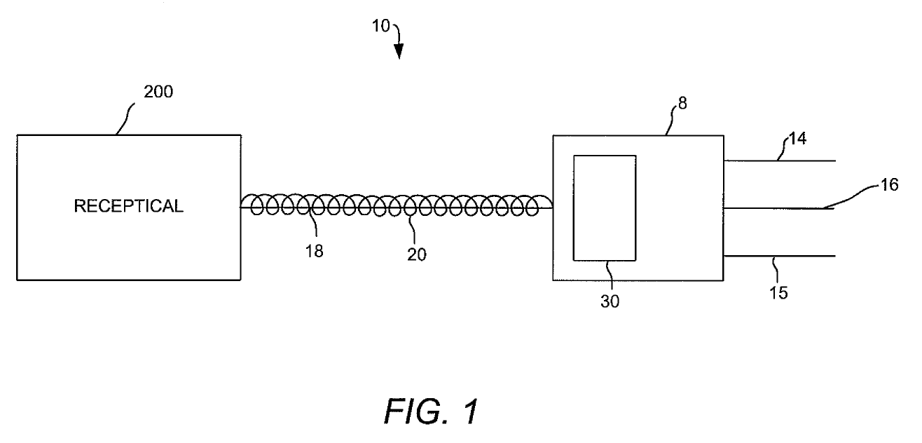

Referring to FIG. 1, there is shown an electrical extension or power cord having built in safety protection in accordance with the principles of the present invention. An electrical plug 8 of the extension cord 10 includes an open neutral during fault detection trip circuit 30. A line end of the circuit is connected to two plug blades 14, 16 to access phase and neutral terminals of a power source. A third plug blade 15 is connected to a ground conductor. The extension cord preferably includes phase, neutral and ground conductors surrounded by a braided, conductive shield. One end of the shield is electrically attached to the fault detection trip circuit and the other end is left unconnected.

Conductive shield 20 is preferably a fine mesh flexible shield of, for example, copper, surrounding a normal two conductor plus ground extension cord. The cross sectional shape of the electric cable can be substantially flat, substantially round or another shape and the conductors can be any standard wire gauge such as 10 AWG, 12 AWG, 14 AWG, 16AWG, 18AWG or any other standard gauge. The electric cable is compatible with standard SPT type cable (parallel jacketed thermoplastic cable) or other standard cables.

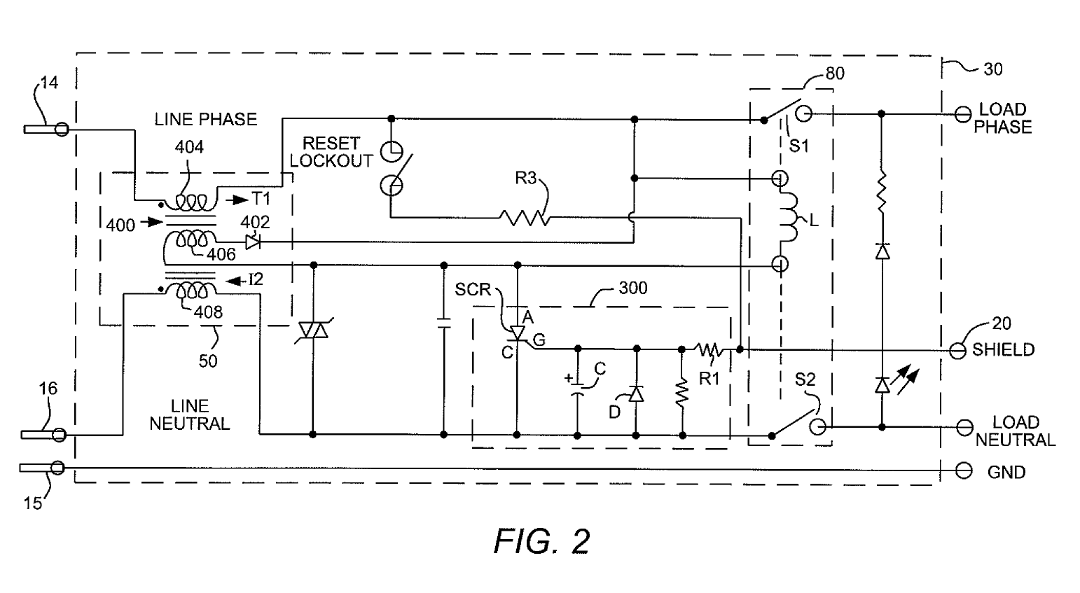

FIG. 2 shows how the electric cable here disclosed can be used as a safety cord by providing fault protection when a neutral conductor is open and a fault condition occurs. Referring to FIG. 2, the open neutral sense circuit with fault detection circuit assures that occurrence of the two condition, an open neutral conductor in combination with another condition, will interrupt the flow of current in the cable. The open neutral sense circuit with fault detection 30, which comprised trip circuit 50, control circuit 300 and an interrupter circuit 80, operates and interrupt the flow of electricity through the cable 18. The arrangement here disclosed allows for the use of a less expensive circuit 30 with a grounded three conductor cable thus eliminating the need for differential current transformers normally required for a current detection interrupter protection device.

The extension cord or cable is a three wire cable having phase, neutral and ground conductors with a conductive wrap 20. The three conductors are connected between the three conductor plug 8 and the three conductor receptacle 200. The conductive wrap or shield is electriclly connected only to the plug. In particular, one end of the conductive wrap 20 is connected to control circuit 300 at the plug and the other end is left unconnected. The unconnected end is supported by the receptacle 200 and electrically isolated from the phase, neutral and ground conductors. The plug end of the phase conductor is connected to the phase blade of the plug through switch S1 and the receptacle end of the phase conductor is connected to the phase terminal of the receptacle. Likewise, the plug end of the neutral conductor is connected to the neutral blade of the plug through switch S2 and the receptacle end of the neutral conductor is connected to the neutral terminal of the receptacle.

Control circuit 300 comprises a solid state switching control circuit which generates a signal upon detecting an open neutral and includes a first resistor R1 connected in-line between the gate of a silicon controlled rectifier SCR and the plug end of the conductive wrap or shield. Resistor R1 limits the current applied to the gate of the SCR. In addition, control circuit 300 includes a parallel network comprising resistor R2, capacitor C and diode D connected between the gate and cathode of the SCR. These components provide a measure of noise immunity and protection against damage across the gate to cathode junction of the SCR.

Interrupter circuit 80 comprises an electromechanical interrupting circuit and includes an energizing coil L and first and second switches S1, S2 connected in-line with the phase and neutral electrical conductors respectively. Switches S1 and S2 are responsive to the flow of current through energizing coil L and are closed when such current is not flowing. In response to the flow of such current they switch from the normally closed position to the fault condition open position. One end of energizing coil L is connected to both the phase conductor, and through a diode 402 to the winding 406 of transformer 400. The other end of the winding 406 is connected to the other end of the coil L and to the anode of the SCR of control circuit 300 as shown. The cathode of the SCR is operatively connected to the shield conductor.

Trip circuit 50 consists of transformer 400 and diode 402. The dots on the transformer windings show the polarity of the windings of the transformer. As shown in FIG. 2, the windings are connected to be in subtractive polarity. The ends of the windings 404 and 408 having the dot notation can be connected to face either the source of electricity or the load. Transformer 400 has three windings 404, 406 and 408. Winding 404 is connected in series with the phase conductor and winding 408 is connected in series with the neutral conductor. Winding 406 in connected, at one end, to diode 402, where the cathode of the diode is connected to one end of the coil L and to the phase conductor. The other end of the winding 406 is connected to the other end of the coil L and to the anode of the SCR in the control circuit 300. The transformer 400 and diode 402 provides an open neutral trip signal used to operate the control circuit 300 when the neutral conductor is open and a fault occurs from the phase conductor to a ground. When such a fault occurs, because the neutral conductor is open, the current 12 in winding 408 is zero and the current I1 in winding 404 is a short circuit fault current which produces a voltage in transformer 400. This voltage energizes relay coil L through diode 402.

If the neutral conductor is open and no fault occurs, the circuit does not trip. If the line and neutral conductors are properly connected, the current I1 equals the current I2 and the trip circuit 50 will not generate a trip voltage.

In the absence of a fault condition along the cable (i.e., the phase and neutral conductors are not energizing the conductive wrap or shield), the SCR is in the normally non-conducting state. In this state, switches S1 and S2 are in their normally closed position and provide a path for current to flow through the extension cord. In a fault condition, conductive wrap or shield is energized which causes the gate of the SCR to be energized. In response thereto, the SCR switches from the normally non-conducting state to the conducting state, to provide a path for current to flow through the energizing coil L to cause switches S1 and S2 to switch from the normally closed position to the fault condition open position and thus interrupt the flow of electricity through the extension cord. Exemplary values for the circuit components illustrated in FIG. 2 are as follows: R1—2000 ohms, R2—1000 ohms, C—0.22 microfarads, diode D—1N4004 and SCR—2N5064.

While there has been shown and described and pointed out the fundamental novel features of the invention as applied to the preferred embodiment, it will be understood that various omissions and substitutions and changes of the form and details of the structures and circuits illustrated and in their operation may be made by those skilled in the art without departing from the spirit of the invention.

What is claimed is:

1. An open neutral during fault detection trip circuit for electrically disconnecting phase and neutral conductors of a power or extension cord from a source of electricity wherein said cord has a phase conductor, a neutral conductor, a ground conductor and a shield conductor comprising:
a control circuit for detecting an open neutral having input terminals coupled to said shield and neutral conductors;
an interrupter circuit having a first set of contacts in series with the phase conductor, a second set of contacts in series with the neutral conductor and a coil for selectively opening said first and second set of contacts; and
a transformer having three windings coupled to said phase conductor, said neutral conductor and said coil of said interrupter circuit to interrupt current in said phase and neutral conductors by opening said first and second set of contacts if an open neutral condition exists when a fault occurs.

2. The circuit of claim 1 wherein the end of said shield that is not coupled to said control circuit is unconnected.

3. The circuit of claim 2 wherein said transformer comprises:
a first winding coupled in series with said phase conductor;
a second winding coupled in series with said neutral conductor; and
a third winding coupled across said coil of said interrupter circuit.

4. The circuit of claim 3 further comprising:
a diode coupled in series with said third winding.

5. The circuit of claim 4 wherein said windings of said transformer are connected in subtractive polarity.

6. The circuit of claim 5 wherein adjacent ends of said first and second windings are each coupled to face a source of electricity.

7. The circuit of claim 5 wherein adjacent ends of said first and second windings are each coupled to face a load.
